(19) United States
(12) Patent Application Publication
(10) Pub. No.: US 2022/0050473 A1
(43) Pub. Date: Feb. 17, 2022

(54) Method and system for modifying image data captured by mobile robots

(71) Applicant: STARSHIP TECHNOLOGIES OÜ, Tallinn (EE)

(72) Inventors: Rao PÄRNPUU, Tabasalu (EE); Kristjan KORJUS, Tallinn (EE); Vahur LAAS, Keila (EE); Kalle-Rasmus VOLKOV, Tallinn (EE); Lauri VÄIN, Tallinn (EE); Sergii KHARAGORGIIEV, Tallinn (EE); Joonatan SAMUEL, Karla küla Rae vald (EE)

(21) Appl. No.: 17/276,147

(22) PCT Filed: Sep. 18, 2019
(86) PCT No.: PCT/EP2019/075004

§ 371 Date: Mar. 13, 2021

(30) Foreign Application Priority Data
Sep. 21, 2018 (EP) 18195936.2

(51) Int. Cl. G05D 1/02; G06N 3/08; B25J 9/16; G06T 5/00; G06F 21/62; G06F 11/36; B25J 13/00

(52) U.S. Cl. CPC G05D 1/0248; G06N 3/08; B25J 9/1697; G05D 2201/0207; G06F 21/6209; G06F 11/3664; B25J 13/003; G06T 5/002

(57) ABSTRACT

A method and system for modifying images captured by mobile robots. The method includes capturing at least one image via at least one visual sensor of a mobile robot; converting the at least one image into image data; storing image data; detecting at least one identifier present in the image data; applying an obfuscation to the at least one detected identifier in the image data to gain obfuscated image data; and providing the obfuscated image data to at least one authorized agent. The system includes at least one capturing component wherein the capturing component is configured to capture at least one image at any positioning of the mobile robots; a converting component wherein the converting component is configured to convert at least one image into image data; a storing component for storing the image data; a processing component. The processing component includes a detecting component for detecting at least one identifier present in the image data; an obfuscating component for obfuscating the identifier detected in at the image data; a transferring component for providing the obfuscated image data to an authorized agent.

### FIELD

The invention lies in the field of modification of image data acquired by mobile robots for ensuring the privacy and data protection of individuals in the vicinity of mobile robots.

### INTRODUCTION

Increasing mobility of goods is a characteristic of modern society and itself represents a globalized, fast and ever-growing industry. Currently, customers have a diverse set of activities, and consequently, products are required to be delivered at hours that best fit costumers' convenience. For instance, deliveries on working days outside of working hours, on weekends and holidays, or even express deliveries of products are becoming more and more regular. Traditional means of delivery, such as couriers, are being abandoned in favor of alternatives requiring less involvement of humans, which may also provide several other advantages such as efficiency of production, energy savings, an optimized and customized delivery time, network effects, increased range of selection for customers to choose from. Moreover, mobile robots may be helpful locally against waste and in transport.

Technology plays an important role in achieving and maintaining this consumption trend that conforms to customer preferences. In particular, robotics offers a highly convenient alternative to advances towards automation of tasks. Robotics has experienced a drastic advancement, and recently it has made possible to incorporate robots among any other traffic participants, such as pedestrians, bicyclists, and cars. Terrestrial robots are capable of accomplishing diverse specified tasks. An autonomous or semi-autonomous robot should be able to drive in many locations facing different obstacles on its way and engages in diverse social interactions. Hence, mobile robots are equipped with several and diverse types of sensors for navigation purposes, which allow them to locate and identify obstacles to be avoided and to reach successfully their final destination. As part of this process, mobile robots process series of data, which may also include images, and these images may include sensitive information regarding people's privacy. For instances, a visual sensor of a mobile robot, such as a camera, may record several images on the displacement of the robot from an initial point A to a final destination B. On the way from A to B, a mobile robot may encounter other traffic participants, which may be recorded by the robot's camera. Such recorded images may contain faces, license plates, house numbers or mailboxes with an engraved full name. Recording of this type of information can be a privacy concern that can be avoided.

As consequence, it is often desirable to obscure, obfuscate or erase video or image recording of faces, license plates, or other identifiable characteristics. This can be preferably done without reducing the usability of the images or video for the original purpose of the camera-equipped device for safety.

Some methods of automatic image and video editing for privacy protection are known in the prior art. These are generally known for security systems in private, commercial or public spaces.

US patent application 2006/0064384 A1 discloses a security system which is nonintrusive of personal privacy of a person in a space comprising at least a first localization sensor subsystem, if any, in the possession of the person; a video surveillance subsystem arranged and configured to collect visual data related to the person in the space; and a computer subsystem coupled to the localization sensor subsystem and video surveillance subsystem to associate a predetermined privacy level with the localization sensor subsystem, and to provide an access control privilege with the localization sensor subsystem, the computer subsystem determining how to present, store and/or retrieve the visual data while meeting predetermined the privacy level associated with the person.

US patent application 2016/0148016 A1 describes a method and apparatus incorporating a security camera of a security system within a residence capturing a sequence of images of a secured area of the residence, a programmed processor of the security system determining that an authorized person is present within the residence, a programmed processor detecting a person within the sequence of images and a programmed processor blurring or reducing a picture quality of an area immediately around the detected person based upon the presence of the authorized person.

U.S. Pat. No. 8,867,853 B2 discloses a processing resource that receives original image data by a surveillance system. The original image data captures at least private information and occurrence of activity in a monitored region. The processing resource applies one or more transforms to the original image data to produce transformed image data. Application of the one or more transforms sufficiently distorts portions of the original image data to remove the private information. The transformed image data includes the distorted portions to prevent access to the private information. However, the distorted portions of the video include sufficient image detail to discern occurrence of the activity in the retail environment.

### SUMMARY

In light of the above, it is an object of the invention to overcome or at least alleviate the shortcomings and disadvantages of the prior art or to provide an alternative solution. In particular, it is an object of the present invention to provide a method and a system for ensuring the privacy of individuals captured in image data of mobile robots' cameras.

These objects are met by the present invention.

In a first embodiment, the invention relates to a method for modifying (such as obfuscating) image data captured by mobile robots.

In one embodiment of the present invention, the method may further comprise the steps of capturing at least one image via at least one visual sensor of a mobile robot, converting the at least one image into image data, processing the image data, storing the image data, detecting at least one identifier present in the image data, applying an obfuscation to the at least one detected identifier in the image data to obtain obfuscated image data, and providing the obfuscated image data to at least one authorized agent. It will be understood that the obfuscation of at least one detected identifier may further imply the partial and/or total obfuscation of individuals.

In order to complete a plurality of tasks, mobile robots may commute following a plurality of trajectories, for example, between an initial point A and a final point B. The mobile robots may use a plurality of the sensors in order to successfully complete the given tasks, which may require acquiring data such as image data. The acquired data may contain sensitive information that may be considered identifiable data. Therefore, the obfuscation of image data may be advantageous, as it may allow to protect the identifiable data of individuals while keeping the image data usable for completion of tasks by mobile robots.

It will be understood that the term obfuscation is intended to represent the process of making a data set, for example, image data, less clear and harder to understand in order to diminish the exposure of identifiable data. In simple words, the term obfuscation is intended to define the actions of making obscure, unclear or unintelligible any image data captured by mobile robots, which may allow to protect information considered identifiable data, while allowing the mobile robots to extract information from the captured data, and therefore being able to bring their assigned tasks to completion.

It will also be understood that the term identifier(s) is intended to define information typically considered identifiable data (such as data that may identify individuals). Such identifiable data may include, for example, but not be limited to, license plates numbers, house numbers, human faces, typed or handwritten text, content of computer screen, cellphones or tablets, and other physical objects that may be considered identifiable data. Therefore, it will also be understood that any time that the term identifier(s) privacy information and/or simply the term identifier(s) is used, it is intended to refer to any identifiable data, such as the mentioned examples.

It will further be understood, that the term authorized agent may refer to a person, such as a software developer and/or an operator. Additionally or alternatively, authorized agent may refer also to an algorithm, such as a neural network and/or machine learning-based algorithm. It may be useful that such an algorithm performs further actions on or with the obfuscated image data. For example, it may be useful to train a specific neural network on obfuscated data.

Furthermore, in one embodiment of the present invention, the method may further include using a camera as at least one visual sensor.

In one embodiment, the method may comprise using an image captured from a constant bitrate stream as image data. The term constant bitrate stream is intended to define capturing a stream of images with the bitrate or the number of bits per second kept the same throughout the capturing step. In simple words, constant bitrate stream may comprise image data that does not optimize media files, and in some instances, constant bitrate stream may be advantageous, as it may allow to save storage space, and it may find further applications, for example, in video streaming and/or for playbacks in a device and/or system that only supports constant bitrate streams. The stream itself may be used for allowing a remote operator to assume control of the mobile robot, should a dangerous or uncertain situation arise. That is, the mobile robot may be transmitting images from its camera live (or close to live) to a remote operator terminal. Such a stream of images can then comprise a constant bitrate stream. Advantageously, the images of the stream may be obfuscated “on the fly”, so that a remote operator terminal does not get access to original image data as captured by the mobile robot's sensors.

In another embodiment, the method may comprise using an original image as image data. The term original image is intended to define the image data captured by the sensors of mobile robots using their maximum (or pre-set) capturing resolution, transmitting and/storing such captured image without applying any type of compression techniques, i.e. it is intended to express the step of capturing images and using them as captured. Therefore, original image data may also be referred to as raw image data, or simple as raw image(s).

It will be understood that original image data not necessarily may be excluded from being further processed to execute the step of image obfuscation. Furthermore, in some instances, capturing original images may be advantageous for a plurality of machine learning purposes in isolated environments.

In one embodiment of the present invention, the method may further comprise using a depth-image as image data, wherein the image resolution is in the range of 30×30 to 300×300 pixels, preferably 75×75 to 230×230 pixels, more preferably 100×100 to 200×200 pixels. In some instances, the use of depth-images may advantageous, as it may allow obtaining space-related information, such as, for example, information relating to the distance of the surface of an object to the viewpoint of mobile robots' sensors. Such depth-image may assume visual representations understandable by an authorized agent, for instance, the nearer areas may be represented by darker tones, and the further areas may be represented by lighter tones of a given color, e.g. as darker-lighter tones in gray scale images. Furthermore, it may also be possible to assign different colors to different areas of the image data to represent the proximity of the area to the mobile robots. In further instances, the use of depth-images may also be advantageous, as it may also allow the identifying surfaces in scenarios affected by homogenously dense (semi)transparent environments, e.g. roads covered by fog or smoke.

In one embodiment, additionally or alternatively, the method may also comprise the step of detecting information considering identifiable data by using algorithms.

For instance, in one embodiment, the method may comprise the obfuscation of image data via blurring of detected identifiers.

Furthermore, in another embodiment of the present invention, the method may additionally or alternatively comprise the step of obfuscating image data by reducing the resolution of the region of the image data containing an individual, i.e. the image data can undergo a resolution reduction in the area concerning an individual. In some instances, selectively reducing the resolution of the image data may be advantageous, as it may allow the obfuscation of the identifiable data, e.g. a person may be obfuscated, which may facilitate people's anonymization, e.g. after reducing the resolution of the image data in the area containing, the person cannot be identified by their hair color, clothing, age, race, etc.

In another embodiment, the obfuscation of image data may be performed by mosaicking detected identifiers.

Moreover, in one embodiment of the present invention, the obfuscation of image data may be performed by privacy preserving photo sharing (P3) of detected identifiers.

In another embodiment, the obfuscation of image data may be performed by binarizing detected identifiers.

Furthermore, the obfuscation of image data may be performed by obfuscating the upper 15-40%, preferably the upper 20-35%, more preferably the upper 25-33% of the image data. For instance, a top part of each frame captured by a camera can be obfuscated. This can be particularly beneficial for cameras installed on sidewalk-travelling mobile robots, since it allows to obfuscate most or all identifiers without specifically detecting them. This is because such sidewalk-travelling mobile robots can be of a size smaller than an average person or individual, and/or have downwards pointing cameras. Then, obfuscating a top part of the image leads to obfuscation of most or all identifiers present in the frame.

In one embodiment, the method may also comprise the obfuscation of image data by detection and displacement of the horizon of the image data corresponding to 15 to 60% of the image height, preferably 20-55% of the image height, more preferably 25-45% of the image height and most preferably 30-35% of the image height.

For instance, the method may allow to detect and obtain the horizon of the entire image and obfuscate everything above the horizon. In other words, it may, for example, obfuscate up to 50% of the image. Furthermore, the obfuscation of image data may also comprise segmenting the image data to identify the horizon, i.e. it may be possible to detect the portion of the image data at which the road becomes the sky, and everything above this detected horizon may subsequently be obfuscated.

The obfuscation of image data may be performed by posterizing detected identifiers.

The method may further comprise providing image data to a neural network in an isolated environment. The term isolated environment can refer to a system not integrated into a general software development system. This can be advantageous as it may allow processing image data while maintaining security, as it is not accessible to any user, e.g. obstacle avoidance and interaction developers are not granted, developers that are not granted access to the image data.

Furthermore, the method may also comprise using an isolated testing environment configured to execute computations based on parameters provided by an authorized developer. The isolated testing environment, which may also simply be referred to as a testing environment may be comprised within the isolated environment and/or may comprise the isolated environment. The testing environment may further bidirectionally communicate with the mobile robots to gain access to original image data and/or sensor data. Additionally or alternatively, the testing environment may further be configured to send outputs and/or reports of tests to an authorized developer. It will be understood that the testing environment may also refer to a production environment from which parameters for modifying other instructions and/or algorithms may be generated and/or retrieved. Therefore, the testing environment may also be referred to as production environment, which may further comprise the execution of instructions, their evaluation and/or the generation of data that may facilitate modifying and/or improving the set of instructions and may further contribute to the development of new and/or different sets of instructions or algorithms. It will be also understood that the production environment can be a segregated environment, further isolated from the isolated environment. It will also be understood that the term test(s) is intended to encompass all tasks executed in the testing environment and/or production environment. Therefore, it may also refer to other tasks different from testing tasks such as, for example, training, evaluation, etc.

In one embodiment, the testing environment may also comprise encrypted data and the access to the encrypted data may be restricted according to types of authorized agents, i.e. not all authorized agents may be allowed to have access to the same data and/or encrypted data. Furthermore, gaining access to the encrypted data may also require a one or multiple time access key that can be generated for specific purposes and/or under supervision. The access key can comprise, for example, a permission added to a user's account and/or a code that can be entered. This may be advantageous, as it may allow preserving individuals' privacy while still allowing for development. That is, this approach may allow developers to test their projects on raw image data, without having access to this image data, which may allow to protect privacy. Additionally or alternatively, the testing environment may further create an audit trail entry for every single request.

The method may further comprise training of the neural network, preferably by transferring the image data to at least one server and/or at least one remote server and/or at least the cloud and training the data in the server, remote server and/or cloud and feeding the neural network back to the storing component for improving the detection of identifiers and/or applying the obfuscation.

The training of the neural network may further comprise using image data for analytics and development in isolated environments without compromising the privacy of individuals in the image data.

A system for obfuscating images captured by mobile robots according to the present invention may particularly comprise at least one capturing component wherein the capturing component may be configured to capture at least one image. Furthermore, the system may also comprise a converting component wherein the converting component may be configured to convert at least one image into image data.

In one embodiment of the present invention, the system may further comprise a storing component for storing image data. It may further comprise an image data processing component comprising a detecting component for detecting at least one identifier present in the image data, an obfuscating component for obfuscating an identifier detected in the image data and/or a transferring component for providing obfuscated image data to an authorized agent.

In one embodiment, the capturing component may be a visual sensor, e.g. a camera.

In another embodiment of the present invention, the capturing component may be a depth image capturing device.

Moreover, in an embodiment of the present invention, the capturing components may also be a sonar image capturing device, e.g. an ultrasonic sensor.

In one embodiment, the system may comprise a light and detection ranging device, e.g. a LiDAR sensor and/or a time-of-flight (ToF) camera as capturing component.

In another embodiment, the capturing component may further be configured to capture images at any positioning of the mobile robots. That is, the capturing component may capture a panorama image of a mobile robot's surroundings. Preferably, a 360° angle can be captured, but in some embodiments angles above 270° may be sufficient.

In one embodiment, the processing component may be a non-transient computer-readable medium comprising instructions which, when executed by a mobile robot, may cause the mobile robot to carry out the image data processing.

In a further embodiment, the storing component may be a non-transient computer-readable medium comprising instructions which, when executed by a mobile robot, may cause the mobile robot to carry out the storing of image data.

Further, the storing component may be a remote storing component, e.g. a server and/or a cloud.

In one embodiment, the capturing component further may comprise microphones, wherein the microphones can be configured for recording audio in order to capture ambient noise.

In one embodiment the ambient noise may be used to analyze the traffic environment. For example, this can be used to detect the presence of an emergency vehicle in the surrounding of the mobile robot. Additionally or alternatively, the audio data can be used in combination with image data to further improve object detection, such as moving vehicle detection.

In another embodiment, the captured ambient noise may be further selectively obfuscated. This can be used to obfuscate voices of any persons coincidentally present in the vicinity of the mobile robot while it is capturing ambient noise. In other words, conversations accidentally captured by the mobile robot's sensors may be obfuscated so that neither the voice nor the content of the conversation can be recognized.

Moreover, the invention may also comprise a computer program wherein the computer program may comprise instructions which, when the program is executed by a computer, may cause the computer to carry out any of explained embodiments.

Furthermore, the invention may also comprise the use of the method embodiment and/or the system embodiments in image data processing. Even further, the invention may comprise the use of the method embodiments and/or the system embodiments for obfuscating image data captured by mobile robots.

It should be noted, that the present invention is not limited to a particular embodiment of data obfuscation. Several embodiments are described herein and are all within the scope of the present disclosure. For instance, one embodiment of obfuscating data described herein comprises obfuscating images comprising a stream. The stream can be transmitted to a remote operator terminal in real time or nearly real time from the mobile robot, so that the robot may be remotely controlled if a dangerous and/or unclear situation arises. For ensuring data and privacy protection of individuals, it is particularly advantageous to obfuscate such a video stream that may be accessed via a remote operator terminal. Another embodiment of the invention may comprise obfuscating images that are not captured as part of a video stream, and that may be captured with a higher resolution. Such images may be stored for further research and development purposes. Obfuscating them can advantageously ensure that original images where individuals and/or identifiers may be present are not accessible to persons. In another example, audio data may be obfuscated in addition to image data. The skilled reader will understand that although the present invention may be applied to a plurality of different use cases or situations, the underlying inventive principle remains unified.

The present technology is also defined by the following numbered embodiments.

Below, method embodiments will be discussed. These embodiments are abbreviated by the letter “M” followed by a number. When reference is herein made to a method embodiment, those embodiments are meant.

M1. A method (100) for modifying image data captured by mobile robots (1000).

M2. The method according to the preceding embodiment wherein the method comprises capturing (102) at least one image via at least one visual sensor of a mobile robot (1000);
converting (106) the at least one image into image data (108);
storing (118) image data (108);
detecting (110) at least one identifier present in the image data (108);
applying an obfuscation (112) to the at least one detected identifier in the image data (108) to gain obfuscated image data; and
providing (116) the obfuscated image data (114) to at least one authorized agent (216).

M3. The method according to embodiment M2 wherein at least one of the visual sensors (202) is a camera.

M4. The method according to embodiment M3 wherein the image data (108) comprises an image captured from a constant bitrate stream.

M5. The method according to embodiment M3 wherein the image data (108) is an original image.

M6. The method according to embodiment M3 wherein the image data (108) is depth-image wherein the image resolution is in the range of 30×30 to 300×300 pixels, preferably 75×75 to 230×230 pixels, more preferably 100×100 to 200×200 pixels.

M7. The method according to any of the preceding embodiments and with features of embodiment M2 wherein the detection of identifiers comprises using algorithms.

M8. The method according to any of the preceding embodiments and with features of embodiments M4 to M6 wherein the obfuscation of image data (108) is performed by blurring detected identifiers.

M9. The method according to any of the preceding embodiments and with features of embodiments M4 to M6 wherein the obfuscation of image data (108) is reducing the resolution of the area of image data (108) containing a person.

M10. The method according to any of the preceding embodiments and with features of embodiments M4 to M6 wherein the obfuscation of image data (108) is performed by mosaicking detected identifiers.

M11. The method according to any of the preceding embodiments and with features of embodiments M4 to M6 wherein the obfuscation of image data (108) is performed by privacy preserving photo sharing (P3) of detected identifiers.

M12. The method according to any of the preceding embodiments and with features of embodiment M6 wherein the obfuscation of image data (108) is performed by binarizing detected identifiers.

M13. The method according to any of the preceding embodiments and with features of embodiment M6 wherein the obfuscation of image data (108) is performed by coloring detected identifiers.

For instance, the detected identifiers may be colored completely with one color, e.g. black, which be advantageous, as it may allow to remove all information related to the detected identifier.

M14. The method according to any of the preceding embodiments and with features of embodiments M4 to M6 wherein the obfuscation of image data (108) is performed by obfuscating the upper 15-40%, preferably the upper 20-35%, more preferably the upper 25-33% of the image data (108).

M15. The method according to any of the preceding embodiments and with features of embodiments M4 to M6 wherein the obfuscation of image data (108) is performed by detection and displacement of the horizon of the image data (108) corresponding to 15 to 60% of the image height, preferably 20-55% of the image height, more preferably 25-45% of the image height and most preferably 30-35% of the image height.

For instance, the method may allow to detect and get the horizon of the entire image and obfuscate everything above the horizon. In other words, it may, for example, obfuscated up to 50% of the image. Furthermore, the obfuscation of image data (108) may also comprise segmenting the image data (108) to identify the horizon, i.e. it may be possible to detect the portion of the image data (108) at which the road becomes the sky, and everything above this detected horizon may subsequently be obfuscated.

M16. The method according to any of the preceding embodiments and with features of embodiments M4 to M6 wherein the obfuscation of image data (108) is performed by posterizing detected identifiers.

M17. The method according to any of the preceding embodiments wherein the method further comprises providing image data (108) to a neural network (120) in an isolated environment (2000).

M18. The method according to the preceding embodiment wherein the method further comprises training of the neural network (120) in an isolated environment (2000).

M19. The method according to the two preceding embodiments wherein the method further comprises using an isolated testing environment (2004) to execute computations based on parameters provided by an authorized developer (2002) wherein the isolated testing environment (2004) is further segregated from the isolated environment (2000)

M20. The method according to the preceding embodiment wherein the testing environment (2004) further engages in bidirectional communication with the mobile robot (1000) to gain access to original image data (108) and/or sensor data (3000).

M21. The method according to the any of the two preceding embodiments wherein the testing environment (2004) further sends outputs and/or reports (2006) of tests to the authorized developer (2002).

M22. The method according to the preceding embodiment wherein the testing environment (2004) further comprises encrypted data.

M23. The method according to the preceding embodiment, wherein the access to the encrypted data is restricted according to type of authorized agents (216), and wherein gaining access to the encrypted data further requires an access key.

M24. The method according the preceding embodiment, wherein the testing environment (2004) further creates an audit trail entry for every request.

M25. The method according to the preceding embodiment and with the features of embodiment M17 wherein the method further comprises processing the image data (108) by the neural network (120) and providing the respectively processed image data (108) to the authorized agent (216).

M26. The method according to the preceding embodiment and with the features of embodiment M2 wherein the method further comprises at least one of the steps of
transferring the image data (108) to at least one server;
training the image in the at least one server; and
using the neural network (120) for improving the detecting of the identifier and/or applying the obfuscation.

M27. The method according to any of the two preceding embodiments wherein the training of the neural network (120) further comprises using image data (108) for analytics and development in isolated environments (2000) while preserving privacy of individuals in the image data (108).

Below, system embodiments will be discussed. These embodiments are abbreviated by the letter “S” followed by a number. When reference is herein made to a system embodiment, those embodiments are meant.

S1. A system (200) for modifying images captured by mobile robots (1000) that is particularly adapted to conduct a method according to any of the preceding method embodiments.

S2. The system according to the preceding embodiment wherein the system comprises
at least one capturing component (202) wherein the capturing component (202) is configured to capture at least one image;
a converting component (204) wherein the converting component (204) is configured to convert at least one image into image data (108);
a storing component (206) for storing image data (108);
an image data (108) processing component (208) comprising
   a detecting component (210) for detecting at least one identifier present in the image data (108);
   an obfuscating component (212) for obfuscating the identifier detected in the image data (108);
   a transferring component (214) for providing obfuscated image data (114) to an authorized agent (216).

S3. The system according to the preceding embodiment wherein the capturing component (202) is a visual sensor, e.g. a camera such as stereo cameras, digital cameras, and/or omnidirectional cameras, light-field camera, etc.

S4. The system according to embodiment S2 wherein the capturing component (202) is a depth image capturing device.

S5. The system according to embodiment S2 wherein the capturing component (202) is a sonar image capturing device, e.g. an ultrasonic sensor.

S6. The system according to embodiment S2 wherein the capturing component (202) is a LiDAR sensor and/or a time-of-flight (ToF) camera.

S7. The system according to any of the preceding system embodiments and with the features of embodiment S2 wherein the capturing component (202) is configured to capture images at any positioning of the mobile robots.

S8. The system according to any of the preceding system embodiments and with the features of embodiment S2 wherein the processing component (208) is a non-transient computer-readable medium comprising instructions which, when executed by a mobile robot, causes the mobile robot to carry out the image data (108) processing according to method embodiment M2.

S9. The system according to any of the preceding system embodiments and with the features of embodiment S2 wherein the storing component (206) is a non-transient computer-readable medium comprising instructions which, when executed by a mobile robot, causes the mobile robot to carry out the storing of image data (108) according to method embodiment M2.

S10. The system according to the preceding embodiment wherein the storing component (206) is a remote storing component (206), e.g. a server and/or a cloud.

S11. The system according to any of the preceding embodiments and with features of the system embodiment S2 wherein the capturing component (202) further comprises microphones, wherein the microphones are configured for recording audio in order to capture an ambient noise.

S12. The system according the preceding embodiments wherein the ambient noise is used to analyze a traffic environment (300).

S13. The system according any of the two preceding embodiments wherein the captured ambient noise is selectively obfuscated.

S14. The system according to any of the preceding embodiments wherein the mobile robot (1000) is configured to operate on pedestrian walkways.

Below, computer program embodiments will be discussed. These embodiments are abbreviated by the letter “C” followed by a number. Whenever reference is herein made to processing unit embodiments, these embodiments are meant.

C1. A computer program comprising instructions which, when the program is executed by a computer, cause the computer to carry out any of the preceding method embodiments.

Below, use embodiments will be discussed. These embodiments are abbreviated by the letter “U” followed by a number. When reference is herein made to a use embodiment, those embodiments are meant.

U1. Use of the method according to any of the preceding method embodiments or the system according to any of the preceding system embodiments in image data processing.

U2. Use of the method according to any of the preceding method embodiments or the system according to any of the preceding system embodiments for obfuscating image data captured by mobile robots (1000).

The present invention will now be described with reference to the accompanying drawings, which illustrate embodiments of the invention. These embodiments should only exemplify, but not limit, the present invention.

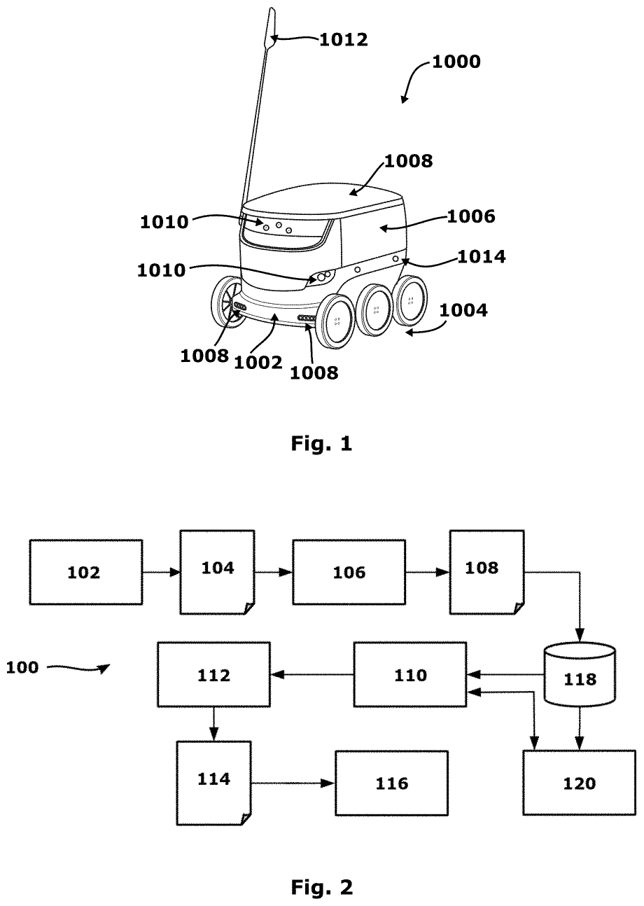

FIG. 1 depicts a schematic example of a mobile robot according to an embodiment of the present invention;

FIG. 2 schematically depicts obfuscating of privacy data in images captured by mobile robots according to an embodiment of the present invention;

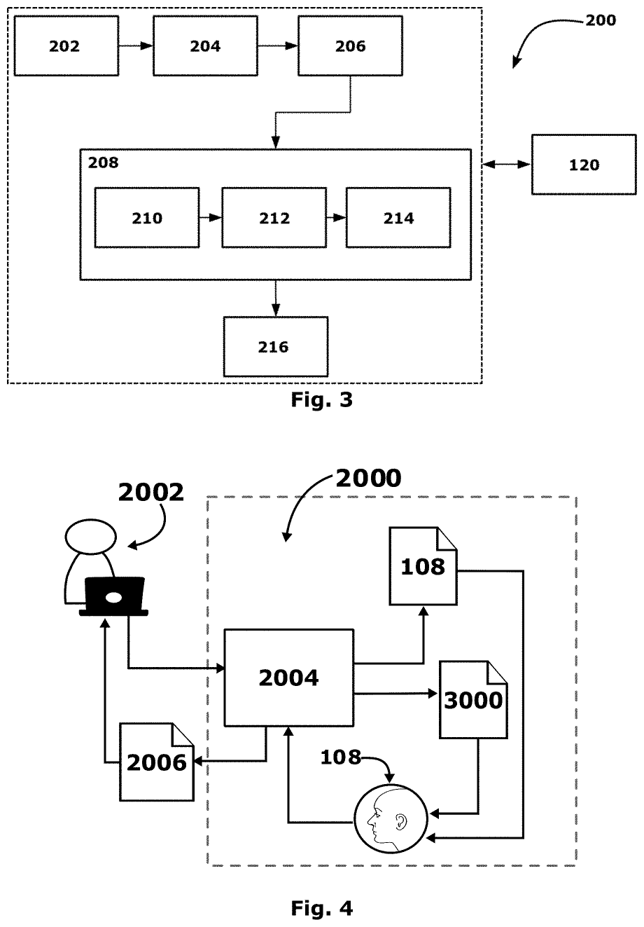

FIG. 3 schematically depicts components of system for the obfuscating of privacy data in images captured by mobile robots according to an embodiment of the present invention;

FIG. 4 schematically depicts of an isolated testing environment according to an embodiment of the present invention;

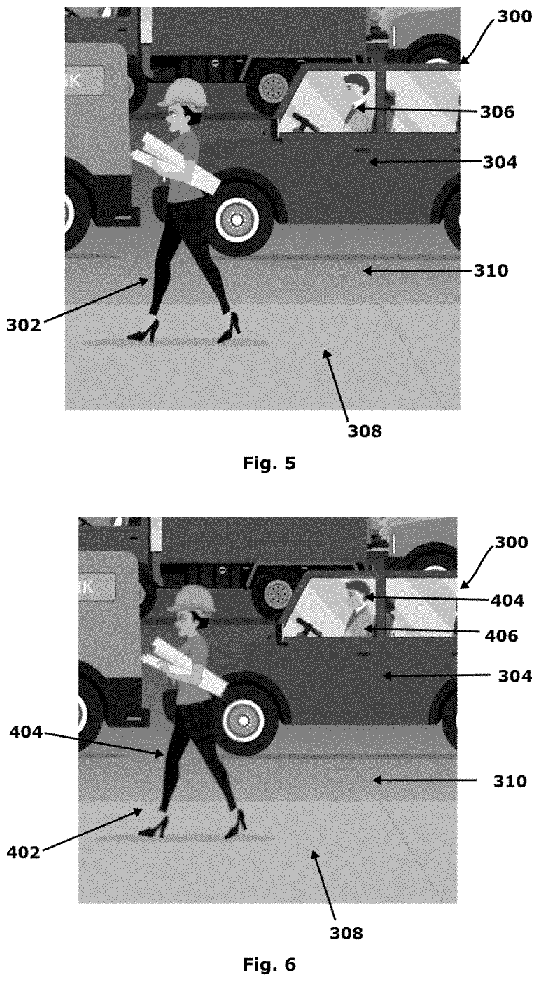

FIG. 5 depicts an image of a traffic environment captured by mobile robots; and

FIG. 6 depicts an obfuscated imaged of a traffic environment captured by mobile robots.

It is noted that not all the drawings carry all the reference signs. Instead, in some of the drawings, some of the reference signs have been omitted for sake of the brevity and simplicity of illustration.

In the following, exemplary embodiments of the invention will be described, with reference to the accompanying figures. These examples are provided to provide further understanding of the invention, without limiting its scope.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, the presence or absence of time delay between steps, can be present between some or all of the described steps.

Embodiments of the present invention relate to methods and systems comprising a robot that may travel autonomously, i.e. without a user controlling its actions during active execution of tasks, or semi-autonomously, i.e. with a user only controlling the robot at some points during its operation. FIG. 1 depicts an example of a robot 1000. Due to the displacement and movement capabilities of the robot 1000, such a robot may also be referred to as a mobile robot 1000. The mobile robot 1000 may form part of a general traffic, e.g. on sidewalks or crossroads, i.e. the mobile robot 1000 may be put in operation alongside with other traffic participants, e.g. pedestrians, cyclists. Therefore, the mobile robot 1000 may require to determine, for instance, its own location, presence of other traffic participants, speed of the traffic or other traffic participants such as pedestrians on sidewalks or speed of cars on crossroads.

In simple words, FIG. 1 depicts a robot 1000 that may be an autonomous robot, that is, a robot not requiring human interaction, or a semi-autonomous robot, requiring human interaction only in a very limited amount. The mobile robot 1000 may be a land-based or land-bound robot.

In simple words, the mobile robot 1000 may be operating fully or partly autonomously, which may also be referred to as autonomous and semi-autonomous mobile robot 1000, respectively. That is, a mobile robot 1000 may travel autonomously, i.e. without a user controlling its actions during active execution of tasks, or semi-autonomously, i.e. with a user only controlling the robot at some points during its operation. It will be understood that the levels of automation may differ from one embodiment to another, for example, in some instances a mobile robot 1000 may operate with human assistance only for execution of some functionalities, such as, in situation where a user (e.g. a customer) receives a delivery but does not know how to proceed. In such situations, an authorized user (e.g. an operator) may remotely give instructions to the mobile robot 1000 (and eventually also to the customer). Another situation where the mobile robot 1000 may operate semi-autonomously is when the robot encounters unknown traffic environments, such as, for example, a sidewalk partially obstructed by an object (e.g. a garbage truck parked on the sidewalk), which may result in a limited transit space (e.g. the space on the sidewalk may be exceedingly narrow for the mobile robot 1000 to cross) and therefore, the situation may require the intervention of an operator. The operator may be using a remote operator terminal. The remote operator terminal may receive data from the mobile robot. For example, the mobile robot may stream a video that it records via its cameras to the remote operator terminal. The images from this video can be obfuscated on the fly, so that the remote operator terminal does not get access to “raw” or originally captured images which may show individuals.

The mobile robot 1000 may comprise a frame 1002 and wheels 1004 mounted on the frame 1002. In the depicted embodiment there are provided a total of 6 wheels 1004. There are two front wheels defining a front wheel set, two center wheels defining a center wheel set and two back wheels defining a back-wheel set. The mobile robot 1000 also comprises a body or housing 1006, which comprises a compartment adapted to house or store goods or, more generally, items. This compartment may also be called a delivery compartment. The body 1006 may be mounted on the frame 1002. The mobile robot 1000 also typically comprises a lid 1008 for closing the body or housing 1006. That is, the lid 1008 may assume a closed position depicted in FIG. 2 and an open position. In the closed position, there is no access to the goods in the delivery compartment of the body 1006. In the open position of the lid 1008 (not depicted), a person may reach into delivery compartment of the body 1006 and obtain the goods from the inside of the body 1006. The mobile robot 1000 may switch from the closed position to the open position in response to a person performing an opening procedure, such as the person entering a code or the person otherwise indicating being in a position to obtain the goods from the mobile robot 1000. For example, the person may access the delivery compartment by using a smartphone application, or the lid 1008 may be automatically opened once the mobile robot 1000 has reached a predetermined location. The mobile robot 1000 may therefore be adapted to deliver the goods or items in the delivery compartment to the person and may therefore be referred to as a delivery robot. The mobile robot 1000 may also comprise lights 1008, such as LEDs.

Furthermore, in the depicted embodiment, the mobile robot 1000 includes a flagpole or stick 1012, which may extend upwards. In certain embodiments, the flagpole 1012 may serve as an antenna. Typical dimensions of the mobile robot 1000 may be as follows. Width: 20 to 100 cm, preferably 40 to 70 cm, such as about 55 cm. Height (excluding the flagpole): 20 to 100 cm, preferably 40 to 70 cm, such as about 60 cm. Length: 30 to 120 cm, preferably 50 to 80 cm, such as about 65 cm. The weight of the mobile robot 1000 may be in the range of 2 to 50 kg, preferably in 5 to 40 kg, more preferably 7 to 25 kg, such as 10 to 20 kg. The flagpole 1012 may extend to an overall height of between 100 and 250 cm, preferably between 110 and 200 cm, such as between 120 and 170 cm. Such a height may be particularly advantageous such that the flagpole 1012 and thus the overall mobile robot 1000 is easily seen by other traffic participants. The center of mass of the mobile robot 1000 may be located within a range of 5 cm to 50 cm from the ground, preferably 10 cm to 30 cm from the ground, such as approximately 20 cm from the ground. Such a center of mass, which center of mass is relatively close to the ground may lead to a particularly stable configuration of the mobile robot 1000.

Furthermore, the mobile robot 1000 may comprise at least one sensor 1010 to obtain information about the robot's surroundings. In some embodiments, the sensor 1010 may comprise one or more light-based range sensor(s), such as a Lidar sensor, a time-of-flight camera and/or a laser range finder. The sensor 1010 (we note that the usage of the singular does not preclude the presence of a plurality) may comprise additionally or alternatively comprise a camera and more particularly, a 3D camera. Such a 3D camera may be a camera comprising a depth sensor and/or a stereo camera. Furthermore, such a 3D camera may be arranged such that it captures images “in front” of the mobile robot 1000, i.e. in the direction the mobile robot 1000 is adapted to travel. That is, the camera may be a front camera and particularly a front stereo camera, or, more generally, the sensor 1010 may point to the front. Thus, the mobile robot 1000 may obtain 3D information about its surrounding environment. In other words, the sensor 1010 may obtain a height profile of objects in the field of view of the camera, i.e. (x, y, z) coordinates. Alternatively or additionally, the mobile robot 1000 may comprise a sensor 1010 arranged to capture images “in the back” of the mobile robot 1000, i.e. a back camera, which may also be referred to as rear camera. Moreover, the mobile robot 1000 may also comprise sensors on each side of the body 1006, which is identified by reference numeral 1014 and may comprise, for example, but not limited to, at least one sonar sensor, e.g. an ultrasonic device.

The mobile robot 1000 may further comprise an auditory sensor such as a microphone and/or an array of microphones (not depicted.

The mobile robot 1000 may transport goods from an initial point A to a final point B, which may be referred to as product delivery, or simply as delivery.

Furthermore, the mobile robot 1000 may follow a sequence of delivery tasks, where the final destination for a first delivery may represent the starting point for the next delivery. This series of displacement from starting points to final destinations may also be referred to as trajectory. Therefore, a mobile robot 1000 may be required to follow a plurality of different trajectories for delivering all assigned products, i.e. the mobile robot 1000 may follow a sequence of trajectories in order to bring a set of tasks to completion.

In simple words, a mobile robot 1000 may be assigned a list of deliveries containing one or more products for one or more final destinations, which may be executed subsequently from an immediate prior final destination. It will be understood that by following this trajectory, the mobile robot 1000, for navigation purposes, may make use of different types of navigation devices such as global positioning systems (GPS) and/or visual sensors such as cameras, stereo cameras, digital cameras, and/or omnidirectional cameras, light-field camera, etc. Visual sensors may represent one or more devices configured for recording images or equivalent information types that may be converted into an image, e.g. sonars, optical phase arrays.

FIG. 2 depicts a schematic embodiment of the obfuscating method 100 for identifiers in images captured by a mobile robot 1000 according to embodiments of the present invention.

In simple terms, the obfuscating method 100 may comprise a capturing step for obtaining at least one image via a visual sensor, and identified by reference numeral 102. The capturing step 102 may also be referred to as image capturing 102, capturing 102 or simply as step 102. In simple words, a mobile robot 1000 may capture an image or set of images during the course of a trajectory, said image(s) identified by reference numeral 104. For instance, the images 104 may be captured for several purposes, such as, for example, identifying and/or avoiding obstacles. The images 104 may also include recordings or sequences of images, i.e. videos. Once the image 104 has been acquired, a converting step takes places for converting the acquired image 104 into image data 108, which is identified by reference numeral 106. The converting step 106 may also be referred to as an image conversion 106, or simply as a conversion 106. In a concrete example, mobile robots 1000 may acquire three different types of image data 108, which may differ in terms of image quality, such as, for example, images from constant bitrate stream 108, original image data 108, and real time transmitted image data 108 to an authorized agent. The image quality may also be referred to as image resolution, or simply as resolution, which may advantageously be chosen according to an intended use-case for image data 108 and the requirements associated to the use-case. In one embodiment, the image data 108 may comprise images from constant bitrate stream 108, which may be referred to as lower-resolution image data 108 and/or as low-resolution image data 108. In another embodiment, the image data 108 may be higher-resolution image data 108, which may also be referred to as high-resolution image data 108.

It will be understood that original image data 108 may comprises images that are used in their original form as they were obtained and therefore no compression or similar resizing method or technique has been applied. For example, but not limited to, an original image data 108 may have an approximate size of 480×920 pixels, however, it will be understood that the dimension of the original image data 108 may vary according to the characteristics of the capturing device in use, i.e. the size of the raw image data 108 may change according to the capturing capabilities of the capturing device. Mutatis mutandis the size of the images from the constant bitrate stream 108 may vary according to the applied compression methods or the requirements of the system, and may for example, but not limited to, be approximately 240×140 pixels, which may advantageous as it may also allow using the images from the constant bitrate stream 108 for feeding a streamed video to an authorized agent. i.e. images from constant bitrate stream 108 may facilitate real time image data 108 transmission.

Subsequently, the image data 108 is scanned and analyzed by algorithms such as, for example, neural network algorithms and/or algorithms that allow obfuscating the top 30% of each image. The process of scanning and analyzing the image data 108 may be referred to as detecting privacy data 110, privacy data detection 110, or simply as detection 110. Image data 108 may include a plurality of information typically considered identifiable data. This information identified as related to privacy may also simply be referred to as identifier, and may include, for example, but not limited to, license plates numbers, house numbers, human faces, or other such examples which may contain information considered or related to the privacy of the general public.

It may also be possible to associate privacy to other identifiers, though less frequently recognized as such, for example, typed or handwritten text, content of computer screen, cellphone or tablets, and several other physical objects that may be considered identifiable data. Therefore, privacy-related information may also be referred to as privacy identifiable information, privacy data or simply as identifier. Detecting identifiers may be crucial for the correct task performance of mobile robots 1000, since it may allow them to correctly and effectively follow a trajectory and collect the required information for making decisions that may trigger further actions or sub actions of assigned tasks. During the detection 110, the system may execute a plurality of pattern recognition-related algorithms. However, it would also be understood that the identification of identifiers and the subsequent pattern recognition refer to only the detection of the presence of identifiers in the surroundings of the mobile robots 1000 and the patterns associated that may allow to infer the presence of identifiers, i.e. during the detection 110 the identity of individuals is not traced nor detected. In more simple words, the operation of mobile robots 1000 does not require the recognition of the identity of individuals but only the detection of identifiers in the surroundings of the mobile robots 1000. Note, that this primarily refers to individuals that the mobile robot 1000 may encounter while traveling to various destinations and performing tasks. As discussed earlier, the mobile robot 1000 may be used as a delivery robot transporting items to individuals which may be referred to as delivery recipients. The delivery recipients may need to be identified, optionally visually, and therefore their identity may be traced and/or confirmed.

Moreover, identifiers, the detection 100 may allow to identify an interaction point in a tight place on a sidewalk, triggering consequently a reaction task, such as, for example, the mobile robot 1000 may identify a tight place on a sidewalk and consequently may stop beforehand, to avoid meeting any other traffic participant. Moreover, it may also be possible that a request is sent to a remote assistance center to which help requests can be escalated. That is, a remote operator terminal can be alerted that the mobile robot 1000 should be remotely controlled until autonomous operation can resume again.

In one embodiment, the detection 110 may be performed by a neural network 120, identifying traffic participants as objects and information such as, for example, orientation detection, radar information (speed, distance, location of approaching objects), stereo point clouds, motion analysis may be provided. Furthermore, additional techniques for detection may be combined.

In another embodiment, the detection 110 may allow the identification of the trajectory, which may be advantageous, as it may allow predicting the inflection point between a traffic participant and the mobile robot 1000. Such a prediction may provide data that would allow changing navigational commands to avoid affecting the performance of the mobile robots 1000 and/or traffic flow on pedestrian walkways/roads by either stopping, slowing, speeding, swerving or a combination of those or other actions.

Successfully detected identifiers may immediately be attenuated and/or obscured, i.e. the detected identifier may immediately be obfuscated, which is identified by reference numeral 112. The obfuscation 112 may be applied by means of different obfuscation methods. For instance, the obfuscation 112 may be obtained by mosaicking (also known as pixelating) identifiers. A further alternative may be obfuscating the identifier by blurring techniques.

Furthermore, obfuscation 112 may also be obtained by implementing a privacy preserving photo sharing, also known as P3, which may allow splitting each image data 108 into a public image and a secret image. It will be understood that the public image may contain enough information for recognizing either the surrounding or other important information contained in the image data 108 such as, for example, information related to safety, but sensitive information considered identifiable data may be excluded. On the other hand, the secret image may contain the full information collected by the image data 108, but it may be intended or conceived as an image data 108 with a reduced size or resolution. Such a secret image may further be encrypted for transferring for further processing, for example, to a neural network 120.

The obfuscation 112 may yield an image containing attenuated privacy information, identified by reference numeral 114. It will be understood that the obfuscated image data 114 may still contain enough information to allow the mobile robots 1000 to identify obstacles, modify trajectories and/or make decision for triggering further actions or sub actions, but keeping the information related to privacy of other traffic participants protected. Subsequently, the obfuscated image data 114 may be transferred to an authorized agent by means of a transferring component identified by reference numeral 116. It will be understood that the transferring component may also be configured for granting access to an authorized agent to look into the obfuscated image data 114.

For instance, low-resolution image data 108 may be transferred from a mobile robot 1000 to a user in real-time. Such as data may not necessarily be stored, however, it may be obfuscated by blurring the top part of the image data 108. The general approach of obfuscating the top part of an image may have computational efficiencies while covering essentially all features. For example, the horizon of the image data 108 may be shifted based on robot inertial data, which may allow more aggressive and useful obfuscation horizons.

Furthermore, this obfuscation method 112 may be replaceable and/or supplementable by, for example, on the fly obfuscation of identifiers in the image right before granting access to the data to a user. On the fly obfuscation of images may be executed by a neural network 120 directly in the mobile robot 1000. Understanding the height of a horizon within a given image may also supply further input information that may facilitate improvements of top part blurring ratios. Thus, a blurring of image data 108 may use the horizon as reference, including changes of few degrees of robots' angle with respect to ground, i.e. an image blurring may follow the horizon to ensure the obfuscation also in situations where the robots' angle relative to the ground changes more than a few degrees, such as for example, 20-30 degrees if the mobile robot 1000 is climbing up/down a curb or is driving on an incline/decline. For instance, based on the up-down movement of the mobile robots 1000, the ratio of the horizon to the whole image may vary in such a way that for most scenarios delimiting the horizon to 25-40% of the image height may allow obtaining optimally obfuscated image data 114.

Image data 108 coming from a mobile robot 1000 may be transferred, for example, but not limited to, by using either direct HTTPS channels from the mobile robot 1000 to a corresponding microservice, or via caching servers by utilizing the same protocol over HTTPS where images resting on disk may be encrypted. The encryption of image data 108 may also be done on the mobile robot 1000. Access to image data 108 may be granted to an authorized agent also through HTTPS for which the authorized agent may be required to provide authentication.

More stringent obfuscation rules may be applied for streamed data, such as, for example, when no user is directly involved with assisting a particular robot, i.e. the mobile robot 1000 operates autonomously. More constricting obfuscation may be possible by either blurring an entire image or by entirely turning a stream off, which may, however, result in lost data if occurrences of accidents, vandalism and/or theft incidents take place. If one or more of the mentioned situations occur, image data 108 may be protected by implementation of, for example, inertial detection of anomalies or/and moving into a data-bleed mode to send the last seconds or tens of seconds over the internet, which may be advantageous, in some instances, as it permits providing information associated with an actual incident. Contrary, if no incident, such as the ones mentioned before, takes place, then an aggressive retention period of minutes or hours can be applied. Moreover, inertial detection may be triggered by anomalies such as: inertia of 30 G for accidents (or even less, preferably 15 G for more sophisticated signal processing for crash detection), smaller jolts by other means such as power draw of motors spiking past the current limit in a sustained way, or robot inclination different from that of an expected map-based model, which may indicate that the mobile robot 1000 has been lifted up.

In case of higher speeds and operations during night times and/or reduced light conditions (where exposure times are longer), motion-caused blurring of images may be a natural side-effect, which, under certain parameters, might be advantageous, as it might negate the necessity of additional obfuscation, e.g. in case of an angular distance versus shutter time as one of the baselines for defining the thresholds.

In one embodiment, obfuscation 112 may undergo an obfuscation rate variation based on the active bitrate of the compression. In this sense, the higher the compression, the less obfuscation may be needed, and vice-versa. In some instances, this approach may be advantageous, as it may be used to normalize image quality while protecting privacy.

Moreover, obfuscation 112 may make certain small critical features such as traffic lights and traffic signs difficult to see. In this case, in one embodiment of the present invention, difficulties associated with obfuscation 112 may be mapped or detected from the stream of image data 108, and a corresponding exception may be applied. For instance, difficulties may easily be detected by mobile robots 1000 by means of statistical certainty, and in certain embodiments, detection of difficulties may be near-perfect certainty by means of computation. Further, it may be possible to establish communication between a user and the mobile robot, e.g. difficulties-related information may be supplied to a user and/or a user may explicitly request for some features not to be obfuscated. In some embodiments, the user may also request to zoom into such small features by, for example, right-clicking on a traffic light. Additionally or alternatively, it may be possible to entirely remove obfuscation e.g. while waiting for road crossing, and/or other very narrow use cases.

Moreover, the type of obfuscation 112 applied to images may differ in terms of the algorithms, i.e. different algorithms may be useful for different small features, e.g. different traffic light types, such as walk-don't walk and/or green-red. In one embodiment, it may possible to apply a detection 110 without an obfuscation 112, e.g. in some cases it may be desired to detect the size of a traffic light, but without obfuscating the traffic light itself. For this purpose, one embodiment of the present invention, may also allow a certain detection error, which may be advantageous, as it may not be possible to obfuscate a wider area around a traffic light, since, generally speaking, at the height and position of a traffic light, it may be quite unlikely to encounter any identifier, e.g. any people. In other words, the system may possess extra criteria for not having detected any persons in an area around the traffic light before removing obfuscation.

In one embodiment, low-resolution video may also be gathered and saved on the robot without obfuscation 112 and/or encrypted. Such low-resolution video may contain data 108, which may be obfuscated by blurring the top third or the like of every image 104 in the image data 108. In some instances, it may be advantageous, as it may allow to gain basic information from the images while obfuscating identifiers. Due to the low quality of the image data 108, if an identifier is far enough to not be covered by the top third of the image data 108, then the identifier may still be unidentifiable. Furthermore, such an obfuscation method may also be replaced by on the fly obfuscation and/or by a pre-processing of images to identify people and obfuscate them.

In one embodiment, it may be possible to reduce the identifiers' detection frequency, and, inertially or based on dead reckoning, shift the blurring horizon between frames to cover the identifier obfuscation. Further, it may also be possible to apply obfuscation 112 on the server side before remote users are granted access to the image. In a further embodiment, it may be possible to include sensor detections in different spectra such as, for example, but not limited to, far infrared (FIR) cameras (including very low-resolution FIR cameras) and/or light detection and ranging (LiDAR) sensors, which may be translated via a coordinate system to visual cameras, and subsequently, obfuscation 112 may be applied in the correct place. The concept may be applied mutatis mutandis to, for example, microphone array-based detection, ultrasonics and/or radars. Additionally and/or alternatively to visual image data 108, remote operation and obfuscation 112 may be also be implemented with depth-image data 108, which may have a depth resolution of 3-5cm. Such image data 108 would not include obvious privacy information but may provide an understanding of the environment. Another alternative might be showing top-down image data 108 of surrounding objects created and/or collected based on depth-imaging.

High-resolution image data 108 may be stored under some specific circumstances, e.g. accidents and system failures, which typically may represent less than 1% of all data. High-resolution image data 108 may be transferred unaltered at the end of a trajectory to a server from a mobile robot 1000 without granting access to any user, i.e. the high-resolution image data 108 may be transferred, without applying obfuscation 112 and without providing the image data 108 to a user, e.g. an operator, directly to a server at the completion of each trip, i.e. at the end of each trajectory. High-resolution image data 108 may be later used for building and testing software to solve failure cases, and make the mobile robot 1000 safer, i.e. high-resolution image data 108 may be used for training neural networks 120, for example, for car and traffic light detection. The obfuscation 112 may also be done by detecting identifiers via a neural network 120, and subsequently running an edge detect and darkening the shapes associated with identifiers (see explanation of FIG. 5)

One embodiment of the present invention may also provide an important aspect of data on a mobile robot 1000, which may be related to incident analysis (similar to black boxes on aircraft), which may require having a “rolling buffer” in which recent data may be stored, and which may continuously be recorded over. For instance, if an anomaly occurs, such as, for example, a shock, data may be preserved and removed and/or decrypted by an authorized agent, along with an audit trail that may contain a recording authorization. In such cases, data may not be obfuscated, but may have a short retention period, and may be encrypted (which may, in a different sense, be a full-frame obfuscation), which may be executed in forensics directly from a mobile robot 1000 and/or via a server-based process.

Moreover, audio may include data relevant to privacy. For instance, a two-way audio may be a useful feature, for example for: resolving concerns with recipient goods quality, agreeing on future deliveries, interacting with people on the street in case concerns are exhibited by pedestrians. Therefore, audio may require for at least one microphone and at least one recording and/or even audio streaming. Mobile robots 1000 may also be unlikely to get full understanding of human language to be able to interact well enough, therefore interaction design principles may call for not implying that the robot can speak, and to have the robot use noises and sounds instead to handle most interaction scenarios during which no recording is done at all and microphones are switched off. When there is an explicit escalation such as the person clearly addressing the robot e.g. by using gestures, then the interaction may be escalated with an explicit dial tone, and a person may be prompted into the conversation. That an audio channel exists may also be indicated with, for example, an indicator light and/or speaker light pulses to the tune of speech spectrum changes. Generally, such data may not need to be recorded at all, and if any recording may be required, a similar protection to that of image data 108 may be applied to reduce the amount of data in a temporal sense in order to improve a mobile robot performance, but not to collect unnecessary data. For instance, recording of audio may be advantageous, as it may allow to detect ambient noise. Ambient noise may be particularly useful to recognize the traffic environment in which the mobile robot may be operating. For example, it may be possible to recognize when a mobile robot is leaving a quiet neighbourhood to approach a busier traffic environment, such as, for example, cross roads of busy traffic roads. Furthermore, ambient noise may be useful to detect some traffic participants, such as, for example, emergency vehicles (e.g. ambulance, police cars on emergency duty, etc.) approaching the surroundings of the mobile robots. Even further, ambient noise may be used in combination with image data to confirm detection of moving vehicles (recognized by the engine noise or similar) or, alternatively, reject a false positive detection. In such scenarios, in case that recognizable voices and/or recognizable conversations were accidentally recorded as part of the ambient noise, the audio may be obfuscated by audio distortion, which may allow to protect a speaker that could have been recorded while keeping the content of the ambient noise understandable. That is, the voice of a person may be distorted, while the presence of, for example, an emergency vehicle and/or footsteps may be detected. This may be for example achieved by audio obfuscation, i.e. by blacking the audio out with noise during the parts where privacy related information may be shared, or entirely deleting those segments of audio containing the sensitive information. Additionally or alternatively, the audio signal may be treated to only allow frequencies of a certain range to be recorded and/or transmitted from the mobile robot to outside sources.

FIG. 3 schematically depicts components of a system 200 according to embodiments of the present invention. In simple terms, the system 200 comprises a capturing component 202, a converting component 204, a storing component 206, a processing component 208 and a neural network 120. The processing component 208 may also comprise a detecting component 210, an obfuscating component 212 and a transferring component 214. It will be understood that the components 210, 212, and 214 may also exist as components of the system 200, but independent from the processing component 208.

In simple words, FIG. 3 schematically depicts components of a system 200 and their interaction to perform the actions described in FIG. 2. The capturing component 202 may comprise a single or a plurality of sensors configured for capturing images, such as, for example, cameras, depth-image devices, and sonar devices. Therefore, the capturing component 202 may also be referred to as visual sensor 202, imaging device 202, imaging sensor 202, capturing sensor 202 or simply as sensor 202.

After the sensor 202 captures at least one image, the image is converted into image data 108 by means of a converting component 204 and fed to a storing component 206, and subsequently, to a processing component 208. The processing component 208 may grant access to the image data 108 to a detecting component 210 in charge of analyzing the image data 108, and subsequently identifying the presence of any identifiers.

Once all the identifiers are successfully localized, the processing component 208 may proceed to grant access to an obfuscating component 212. The obfuscating component may be a non-transient computer readable medium containing instructions which, when executed, performs an attenuation of the identifiers to obtain an obfuscated image data 114. The obfuscated image data 114 may then be provided to a transferring component 214, responsible for transferring or granting access to the obfuscated image data 114 to an authorized agent through a terminal 216.

Moreover, the storing component 206 may be configured to store the image data 108, which may be retrieved by a neural network 120. The neural network 120 may use the information contained in the image 108 for training pattern recognition algorithms, for modifying obfuscation thresholds, and other parameter or actions or sub actions relating to the image processing 100. In simple words, the image data 108 stored in the storing component 206 may be available to a neural network 120 for further machine learning. The trained algorithm may then be sent back to a local network or to the robot. For instance, the training of the neural network may comprise the generation of manually annotated data based on obfuscated images, i.e. bounding boxes. Subsequently, the neural network is trained based on annotated data, which may allow the neural network to perform improved detection of identifiers. Furthermore, the neural network may train itself using original image data 108 in an isolated environment 2000, which can also be referred to as segregated environment 2000. As a result, an improved version of the neural network may be deployed, which may also be used for detecting image data 108. Thereupon, the neural network's pre-annotated data may also be used in the annotation processes.

The image processing 100 may, for example, take place using a server, e.g. Amazon Web Services Elastic Compute Cloud (AWS EC2). Images may be stored in a cloud, such as, for example, on Amazon Web Services Simple Storage Service (AWS S3). Raw images may come in as special container files, which may contain image data 108 and metadata needed to assemble the image exactly as it was captured via the mobile robot 1000. Incoming image data 108 may be passed through the neural network 120, which may output detected objects and coordinates of the corners of the boxes around the objects. Image data 108 with one or more detected identifiers (e.g. persons as a specific object type) may be sent through the obfuscating component for removing the identifiers from the image data 108 by, for example, greying out the bounding box and drawing lines around contrast areas. As a result, a grey area with very rough lines indicating the shape of the removed object may be obtained. The data detected by the neural network 120 may be stored in a database for later use.

FIG. 4 schematically depicts concepts of an isolated environment 2000, which may, for example, but not limited to, be used for testing purpose, e.g. it may allow users 2002, e.g. developers, to test their projects. In simple terms, the isolated environment 2000 may comprise a testing environment conceptually identified by reference numeral 2004, which may be an environment further segregated from the isolated environment 2000. The testing environment 2004 may receive information such as, for example, testing parameter(s), from a user 2002. These parameters may, for instance, include, but not be limited to, test name, required and/or expected outputs, a plurality of algorithms to be executed on/with image data 108, etc. The testing environment 2004 may further be configured to apply the parameters to image data 108, as schematically depicted in FIG. 4. Moreover, the testing environment 2004 may further be configured to request information from a mobile robot 1000 and the requested information may contain a plurality of parameters identified by reference numeral 3000 and referred to as robot sensor data 3000, robot data 3000 or simply as sensor data 3000. The robot sensor data 3000 may comprise a plurality of measurements and information recorded by a mobile robot 1000. For instance, it may comprise delivery routes, time of traveling to execute delivery routes, object detection measurements, etc. Subsequently, the testing environment 2004 may retrieve information, such as, for example, raw image data 108, identified by reference numeral 108. This raw image data 108 may be used by the testing environment 2004 to execute the algorithms and/or parameters previously supplied by a user 2002 and consequently a data set containing the results of the test may be generated and is identified by reference numeral 2006. However, the user 2002 may not have access to any unobfuscated image data 108, i.e. the developer 2002 may not have access to the raw image data 108, but only to the result data set 2006 of the test environment 2002. It will be understood that the result data 2006 does not contain the raw image data 108, nor any unobfuscated image data 108, but only the results concerning the project of the user 2002. This may be advantageous, as it may allow simultaneously ensuring privacy of individuals which also allowing computations and tests to run on unaltered (i.e. unobfuscated) data. In other words, it may allow the users 2002 to test their projects on raw image data 108, without having access to this image data, which may further allow to protect privacy. In simple words, the isolated environment 2002 may further comprise further segregated components, areas and/or modules, for instance, the testing environment 2004, the sensor data 3000, the image data 108, the raw image data 108, etc. Furthermore, original images may be stored on a server, e.g. on Amazon Web Services Simple Storage Service (AWS S3), and may further be encrypted using an encrypting system, such as, for example, Amazon Web Key Management System (AWS KMS). Therefore, in order to access the encrypted image data 108, any user may need to authenticate themselves, as well as needing to belong to a specific user group and further may be required to provide an access key for granting access to the requested image data 108. Regardless of whether access is granted or not, an audit trail entry may be created for every single request.

The capturing component 202 may comprise at least one visual sensor, e.g. one or more cameras, configured for gathering information regarding the environment, i.e. surroundings, of mobile robots 1000.

FIG. 5 depicts a schematic simulated example of an image gathered by a capturing component 202.

In simple terms, FIG. 5 depicts an image of a traffic environment 300 captured by a mobile robot 1000. The traffic environment 300 may comprise, for example, a sidewalk 308 and a road 3010. Furthermore, the traffic environment 300 may comprise: traffic participants such as, for example, a pedestrian on a sidewalk 308, conceptually represented by a humanoid icon 302; several motorized vehicles on the road 310, from which an icon presenting a car 304 is taken as example in this description. The car 304 may be transporting other traffic participants, such as, for example, the humanoid icon 306, which schematically represents occupants of the car 304, more particularly, a driver 306.

It will be understood that FIG. 5 represents only a mere frame or image 104 captured by a mobile robot 1000, but in fact, several additional images 104 may be also captured simultaneously. That is, the mobile robot 1000 may comprise a plurality of cameras with different orientations capturing a plurality of image frames simultaneously to obtain a more complete image of its surroundings (such as a panorama image). For instance, if the mobile robot 1000 is in a stationary position, the traffic environment 300 may vary over time, including in a short period of time, such as, for example, few seconds. During this period, the mobile robot 1000 may capture one or more images 104, which may contain the same or different traffic participants. In simple words, if a mobile robot 1000 is in a steady state, the capturing component 202 may gather one or more images 104, which capture one or more identifiers crossing in front of the visual sensor 202 of the mobile robot 1000. Such captured identifiers may be related to privacy, therefore an obfuscation 112 may be applied to yield an obfuscated image 114, as explained below.

FIG. 6 depicts an exemplary schematic obfuscation applied on an image of a traffic environment 300 captured by a mobile robot 1000. FIG. 5 further depicts an obfuscated image 114 of two identifiers 302 and 306 associated with identifiable data, and conceptually identified as identifiers 402 and 406. The identification of identifiers 302 and 306 is conceptually represented by a contouring selection, which is indicated with reference numeral 404. The contouring selection 404 may also be referred to as bounding boxes 404. For example, a neural network 120 may be used to detect bounding boxes 404 of identifiers (e.g. 402 and 406), and this meta-data may be included with the image. Based on the included coordinates of the bounding box, identifiers may be obfuscated on demand by the means of, for example, making them black and white, grayscales and/or monochromes, for instance, by averaging color components together. In simple words, the use of a large mean filtering window may allow, first, to blur the image, and second, to assign annotations in vertical and horizontal lines on top of the original image, e.g. with a solid color. In some instances, this may advantageous, as it may permit preserving edges between the environment 300 and identifiers, in most cases, while also masking smaller identifiable features with a lot of details e.g. faces, making them un-identifiable, i.e. obfuscating the details therein.

In one embodiment, it may be possible to use more advanced obfuscation 112, such as, for example, manipulation of facial features. Furthermore, an identifier (e.g. a person or other feature such as a car license plate) may also be obfuscated by other methods than blurring such as blanking out entirely, and/or pixelating. Pixelation of identifiers may be achieved by using, for example, a block size around 1/30 of the image size, replacing detected identifiers with a generic figure and/or other obfuscation methods. Pixelation size of very close identifiers may also be defined based on degrees. In alternative embodiments, obfuscation of images may be achieved by using other types of approaches, which allow to minimise privacy data in the image, e.g. showing only lines or line motion from the images, which may allow to detect objects without any identifier.

As mentioned before, regardless of the type of image data 108, the general approach of the present invention may be granting access to original image data 108 to a neural network 120, and to an authorized agent only to obfuscated image data 114. In some instances, this general approach may be advantageous, as it may allow for development of safer and less prompt to failure mobile robots 1000 without compromising privacy data. Furthermore, in some instances, algorithms that may not require an original image 108 to successfully execute tasks (e.g. identifiying car headlights), may use obfuscated image data 114. This may be advantageous to preserve sensitive privacy-related data, as it may allow limiting access to users, for instance, developers may not be granted access to original images, therefore preserving people's privacy.

It will be understood that obfuscation 112 may be applied to all image data 108 captured by mobile robots 1000 at the moment of a user's request to use and/or access this data (rather than at the moment of capturing the image). Furthermore, it may be possible to test algorithms inside a server using the image data 108 without granting access to any user. Even though a user may specify the parameters and outputs of their work, the processing may be executed in an isolated environment 2000 without image data 108 being accessible to any user. Furthermore, it will be understood that the processing executed in an isolated environment 2000 is a reference to a testing environment and it may be used to run tests on raw images without giving access to developers. The isolated environment further may comprise a system not integrated into a general software development system, which may be advantageous as it may allow processing image data 108 while maintaining security and/or privacy, as it is not accessible to any user, e.g. developers that are not granted access to the image data 108.

In simple terms, the isolated environment 2000 may send commands to a system. These commands can include, for example, which type of test one wants to run so that the system can run the instructed tests, and no access can be granted to any person to the internal workings of the system. In other words, the system can run the test on its own and once the test is finished, it can output the result without giving access to the original image data 108. Moreover, minimizing the amount of data processed for development purposes may allow to maximize privacy protection. In simple words, important measures here may contain anomaly detection on the signal stream itself and may limit the data by several orders of magnitude in a temporal sense and possibly also in terms of resolution, e.g. by looking at relevant subsets only. However, single sensor anomaly detection may be possible, but limited in its capabilities. Therefore, a powerful use of the present invention may be the use of sensor diversity to cross-reference anomalies across multiple sensors, which should get the same result in an obstacle detection sense but operate on very different physical principles. In some instances, this use may be advantageous, as in many cases it may only require milliseconds to seconds of data out of hours of regular data.

In one embodiment, based upon development of the underlying technology, it may possible to expand the obfuscation 112 to other types of data, which may be considered identifiable data, such as, for example, but not limited to, building addresses, audio recordings (e.g. voice distortion). For instances, some exceptional cases, controlled and audit trailed processes may exist for gaining access to image data 108, which may advantageous, in some instances, as it may include e.g. requests from authorities and/or internal data not containing personal data.

While in the above, a preferred embodiment has been described with reference to the accompanying drawings, the skilled person will understand that this embodiment was provided for illustrative purpose only and should by no means be construed to limit the scope of the present invention, which is defined by the claims.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1-18. (canceled)

19. A method for modifying image data captured by mobile robots, wherein the method comprises:
capturing at least one image via at least one visual sensor of a mobile robot;
converting the at least one image into image data;
storing the image data;
detecting at least one identifier present in the image data;
applying an obfuscation to the at least one identifier detected in the image data to gain obfuscated image data; and
providing the obfuscated image data to at least one authorized agent.

20. The method according to claim 19 wherein the image data is at least one of:
original image data; and/or
image captured from a constant bitrate image data; and/or
depth-image data.

21. The method according to claim 19 wherein obfuscation of image data is performed by at least one of:
image blurring; and/or image mosaicking; and/or image binarizing; and/or image coloring; and/or image posterizing

22. The method according to claim 19 wherein obfuscation of image data is performed by obfuscating an upper 15-40%, preferably an upper 20-35%, more preferably an upper 25-33% of the image data.

23. The method according to claim 19 wherein obfuscation of image data is performed by detection and displacement of an horizon of the image data corresponding to 15 to 60% of image height, preferably 20-55% of the image height, more preferably 25-45% of the image height and most preferably around 30-35% of the image height.

24. The method according to claim 19 wherein the method further comprises granting access to image data to a neural network wherein the method further comprises using the image data for training the neural network in an isolated environment .

25. The method according to claim 24 wherein the method further comprises at least one of:
transferring the image data to at least one server;
training the data in the at least one server; and
using the neural network for improving detection of identifiers and/or applying obfuscation.

26. The method according to claim 24 wherein the training of the neural network further comprises using image data for analytics and development in isolated environments wherein the isolated environment comprises a further isolated testing environment.

27. The method according to claim 26 wherein the method further comprises using the isolated testing environment to execute computations based on parameters provided by an authorized developer wherein the isolated testing environment is further segregated from the isolated environment.

28. The method according to claim 27 wherein the testing environment further engages in bidirectional communication with the mobile robot to gain access to original image data and/or sensor data.

29. The method according to claim 27 wherein the testing environment further sends outputs and/or reports of tests to the authorized developer and wherein the testing environment further comprises encrypted data.

30. A system for modifying images captured by mobile robots, the system comprising:
at least one capturing component wherein the capturing component is configured to capture at least one image at any positioning of the mobile robots;
a converting component wherein the converting component is configured to convert at least one image into image data;
a storing component for storing the image data;
a processing component comprising:
a detecting component for detecting at least one identifier present in the image data;
an obfuscating component for obfuscating the identifier detected in at the image data; and
a transferring component for providing obfuscated image data to an authorized agent.

31. The system according to claim 30 wherein the capturing component is at least one visual sensor configured for capturing images wherein the visual sensor comprises at least one of the following capturing components:
a camera; and/or
a depth image capturing device; and/or
a sonar image capturing device; and/or
a light and detection ranging device.

32. The system according to claim 30 wherein the capturing component is configured to capture images at any positioning of the mobile robots.

33. The system according to claim 30 wherein the storing component is a remote storing component, such as a server and/or a cloud.

34. The system according to according to claim 30 wherein the capturing component comprises microphones configured for recording audio in order to capture an ambient noise and wherein the ambient noise is selectively obfuscated.

35. The system according to claim 30 wherein the storing component is non-transient computer-readable media comprising instructions which, when executed by a mobile robot , causes the mobile robot to carry out their corresponding steps according to claim 1.

36. The system according to claim 30 wherein the processing component is non-transient computer-readable media comprising instructions which, when executed by a mobile robot , causes the mobile robot to carry out their corresponding steps according to claim 1.
